(19) United States
(12) Patent Application Publication
(10) Pub. No.: US 2009/0211559 A1
(43) Pub. Date: Aug. 27, 2009

(54) ENGINE FUEL SUPPLY CIRCUIT

(76) Inventors: Andy Blaine Appleton, Cedar Falls, IA (US); Ronnie Franklin Burk, Cedar Falls, IA (US)

Correspondence Address: DEERE & COMPANY, ONE JOHN DEERE PLACE, MOLINE, IL, 61265, US

(21) Appl. No.: 12/035,900

(22) Filed: Feb. 22, 2008

(51) Int. Cl. F02M 37/04

(52) U.S. Cl. 123/511; 123/514

(57) ABSTRACT

A fuel supply circuit for a Diesel engine includes fuel injectors, a fuel tank, a main pump for delivering fuel to the injectors, and a variable flow charge pump for delivering fuel from the tank to an inlet of the main pump, and a surplus fuel line communicating unburned fuel from the injectors to an inlet of the charge pump. The circuit also includes a temperature sensor which senses a temperature of fuel discharged by the charge pump, and a pressure sensor which senses a pressure of fuel discharged by the charge pump. A bleed line communicates fuel from an outlet of the charge pump to the tank. A solenoid operated bleed valve and a pressure relief valve control flow through the bleed line. An electronic control unit controls the charge pump and the bleed valve as a function of the sensed parameters.

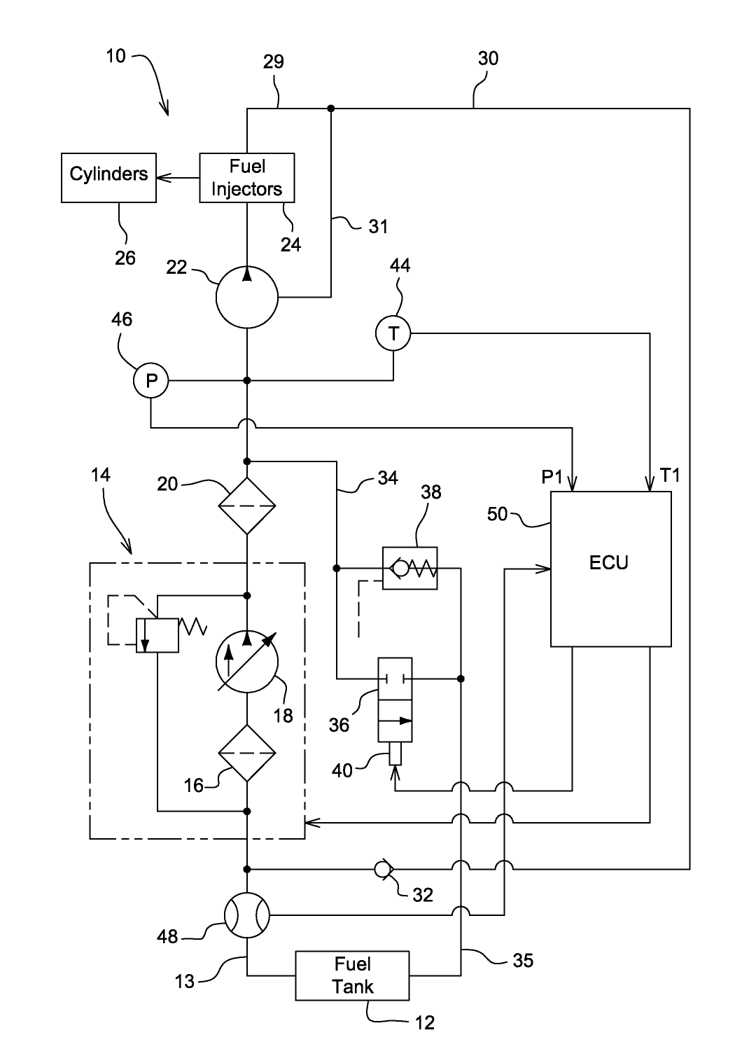

### FIELD OF THE INVENTION

The present invention relates to a fuel supply circuit, such as for a Diesel engine.

### BACKGROUND OF THE INVENTION

In conventional Diesel engine fuel supply systems, fuel is drawn from a supply tank, pumped through a filter and delivered to a high-pressure injection system. The fuel has maximum temperature and minimum pressure requirements. A portion is leaked off of the injection rail and a portion is bled from the high-pressure pump with the balance being burned in the engine. These two bleed streams are hotter than the temperature of fuel in the tank. If necessary, the bleed streams are cooled and returned to the tank. Alternatively, the fuel can be cooled as it leaves the tank and before the high-pressure pump with the charge pump being on either side of the cooler in the circuit.

In conventional systems, more fuel is pumped by the charge pump than required by the high-pressure pump, and this surplus fuel is bled off from the high pressure pump. The warmed surplus fuel returning to the tank heats the fuel in the tank. To cool the fuel to the requirements of the pumping system, all the fuel in the tank must be cooled. The several flow paths into and out of the fuel tank make measurement of the actual fuel consumed by the engine difficult. In addition, plugging of a bleed orifice in the typical system can cause air to build up in the system, which can cause system failure or degradation.

### SUMMARY OF THE INVENTION

Accordingly, an object of this invention is to provide a fuel supply circuit which does not require a separate cooler to cool surplus fuel returned to the fuel tank.

A further object of the invention is to provide such a circuit with a flow sensor which provides a signal representing the amount of fuel burned in the engine.

These and other objects are achieved by the present invention, wherein a fuel supply circuit includes fuel injectors, a fuel tank, a main pump for delivering fuel to the injectors, and a variable flow charge pump for delivering fuel from the tank to an inlet of the main pump, and a bleed line communicating unburned fuel from the injectors and from the main pump to an inlet of the charge pump. The circuit also includes a temperature sensor which senses a temperature of fuel discharged by the charge pump, and a pressure sensor which senses a pressure of fuel discharged by the charge pump. A bleed line communicates fuel from an outlet of the charge pump to the tank. A solenoid operated bleed valve and a pressure relief valve control flow through the bleed line. An electronic control unit controls the charge pump and the bleed valve as a function of the sensed parameters.

### BRIEF DESCRIPTION OF THE DRAWINGS

The sole FIGURE is a simplified schematic diagram of a Diesel engine fuel supply system embodying the invention.

### DESCRIPTION OF THE PREFERRED EMBODIMENT

The fuel supply system 10 includes a fuel tank 12 and a conventional charge pump unit 14 which includes a filter 16 and a variable rate electric charge pump 18. Charge pump unit 14 draws fuel from the tank 12 through supply line 13, and pumps fuel through another filter 20 to the inlet of a conventional high pressure pump 22. Pump 22 supplies pressurized fuel to the engine fuel injectors 24 which deliver fuel to the engine cylinders 26.

According to the present invention, fuel surplus or return lines 29 and 30 communicate surplus fuel from the fuel injectors 24 to the inlet of charge pump unit 14 via a check valve 32 which permits one-way flow from fuel injectors 24 to the inlet of unit 14. Lines 31 and 30 communicate leakage fuel from pump 22 back to the inlet of pump unit 14.

A first bleed line 34 communicates fuel from the outlet of charge pump unit 14 to an inlet of a solenoid operated air purge/bleed valve 36 and to a pressure relief valve 38 connected in parallel with valve 36. A second bleed line 35 communicates fuel from the outlets of valves 36 and 38 to the tank 12. Valve 36 is normally closed and is movable to a open position by its solenoid 40. Valve 38 opens when the pressure in the line between filter 20 and pump 22 exceeds a threshold pressure P2, such as 50 kPa. Valve 36 can be used to assist in priming the charge pump 18, if it has poor priming characteristics. Air can be bled from the system by exceeding the threshold opening pressure of the relief valve 38, or by electrically opening the valve 36.

A temperature sensor 44 senses the temperature of the fuel between filter 20 and pump 22 and supplies an electric fuel temperature signal T1 to an electronic control unit (ECU) 50. A pressure sensor 46 senses the pressure of the fuel between filter 20 and pump 22 and supplies an electric fuel pressure signal P1 to the ECU 50. A fuel flow sensor 48 may be placed in the fuel supply line 13 to supply a fuel flow signal to the ECU 50. The ECU 50 is preferably a programmable logic controller. The ECU controls valve 36 and the rate of the charge pump 18 as a function of the sensed temperature, pressure and/or fuel flow.

This system permits closed loop control of the variable charge pump 18 as a function of sensed pressure, so that the charge pump 18 supplies only the necessary amount of fuel to the high pressure pump 22. In this way, the pressure between the charge pump 18 and high pressure pump 22 would be maintained within a defined band. Such a system is more efficient with lower pumping losses.

As part of the initial filling process of the system and when a fuel tank runs dry, air may be present in the system. To discharge the air, the ECU 50 can be programmed to command the charge pump 18 to pump excess fuel. This excess fuel will carry the air over the relief valve 38 or air purge/bleed valve 36 and back to the tank 12 where the air can separate from the fuel. This command can be time based or low pressure based, and can be coordinated with a command to open the air purge/bleed valve 36.

With hot fuel being communicated back to the inlet of the charge pump 18, the flow sensor 48 in line 13 will provide an accurate measurement of fuel burned in the engine cylinders 26, except when fuel is flowing through line 34 and through air purge/bleed valve 36 or relief valve 38. The condition of relief flow will be known to the ECU controlling logic by comparing the sensed pressure to a pressure relief valve value or setting to indicate a by-pass or no by-pass condition. If the sensed pressure is higher than the relief valve setting, flow must be occurring across the valve as it would be open. The relief flow condition is only expected during startup and failure events. Therefore, a measurement of fuel consumed during normal operating conditions can be provided by the flow sensor 48 in line 13 from the tank 12.

The flow sensor 48 is preferably a conventional known commercially available flow meter, and provides an electronic flow signal to the ECU 50 or to a separate control unit (not shown). If the electronic flow signal is provided to a separate controller, the controller which controls the charge pump 18 may also have as an output signal a Boolean variable indicating over-driving of the charge pump 18. This would provide an indication when the fuel flow measurements from the flow sensor 48 are not to be taken as accurate as some quantity of fuel is flowing back to the tank and not being burned in the engine cylinders 26. The control unit may execute other algorithms to generate an estimate of fuel consumption, or to generate a signal that drives the fuel injectors 24, for example.

The returned fuel flowing through line 30 (from pump 22 and injectors 24) will mix with fuel flowing through line 13 from the tank 12. The fuel from the tank 12 will be cooler than the returned fuel. In certain conditions, the temperature of this mixed fuel can exceed temperature limitations of the fuel system. This temperature T1 is sensed by temperature sensor 44 which communicates a temperature signal to an input of the ECU 50. If the temperature T1 exceeds a limit temperature, the ECU can be programmed to command the charge pump 18 to increase flow from the tank 12. This lowers the temperature of the mixed fuel delivered to the high pressure pump 22 to within acceptable limits while excess fuel flows back to the tank 12 via valves 36 or 38. As a result, the fuel in the tank 12 functions as a heat sink and allows times of very high fuel leak-off temperature of the system to be reduced to acceptable systems limits via additional blending of the lower temperature tank fuel. Fuel cooling devices can be reduced in size or eliminated.

In the situation where the temperature T1 exceeds the limit temperature, the fuel flow measurement from sensor 48 will not accurately represent the amount of fuel being burned in the cylinders 26. Thus, the ECU 50 could be programmed to use temperature T1 and supersede the normal closed loop control of the charge pump 18 as a function of the pressure P1. Preferably, the relief valve pressure setting P2 would be set sufficiently above P1 as to prevent hunting of the logic.

While the present invention has been described in conjunction with a specific embodiment, it is understood that many alternatives, modifications and variations will be apparent to those skilled in the art in light of the foregoing description. For example, the control signals to the fuel charge pump and to the air purge/bleed valve 36 may be a voltage, amperage, pulse-width modulated or servo-mechanical. The fuel flow signal from optional sensor 48 may be digital or analog. The ECU 50 may be programmed to receive and process various diagnostic signals as appropriate. Accordingly, this invention is intended to embrace all such alternatives, modifications and variations which fall within the spirit and scope of the appended claims.

We claim:

1. An engine fuel supply circuit comprising:
a fuel injector;
a fuel tank;
a main pump for delivering fuel to the injector;
a pressure sensor sensing a pressure of fuel discharged by the charge pump;
a variable flow charge pump for delivering fuel from the tank to an inlet of the main pump;
a surplus line communicating unburned fuel from the injector and the main pump to an inlet of the charge pump; and
a control unit for controlling the charge pump as a function of the sensed pressure.

2. The fuel supply circuit of claim 1, further comprising:
a fuel flow sensor for sensing a rate of fuel flow flowing out of the fuel tank and towards the inlet of the charge pump.

3. The fuel supply circuit of claim 1, further comprising:
a temperature sensor sensing a temperature of fuel discharged by the charge pump;
a bleed line communicating fuel from an outlet of the charge pump to the tank;
a solenoid operated bleed valve controlling flow through the bleed line; and
a control unit for controlling the charge pump and the bleed valve as a function of the sensed temperature.

4. The fuel supply circuit of claim 1, further comprising:
a pressure sensor sensing a pressure of fuel discharged by the charge pump; and
a control unit for controlling the charge pump and the bleed valve as a function of the sensed pressure.

5. The fuel supply circuit of claim 1, further comprising:
a temperature sensor sensing a temperature of fuel discharged by the charge pump;
a pressure sensor sensing a pressure of fuel discharged by the charge pump;
a bleed line communicating fuel from an outlet of the charge pump to the tank;
a solenoid operated bleed valve controlling flow through the bleed line; and
a control unit for controlling the charge pump and the bleed valve as a function of the sensed temperature, and for controlling the charge pump and the bleed valve as a function of the sensed pressure.

6. The fuel supply circuit of claim 1, further comprising:
a bleed line communicating fuel from an outlet of the charge pump to the tank;
a solenoid operated bleed valve controlling flow through the bleed line; and
a control unit for controlling the charge pump and the bleed valve as a function of the sensed temperature, and for controlling the charge pump and the bleed valve as a function of the sensed pressure.

7. The fuel supply circuit of claim 1, wherein:
the fuel flow sensor senses a rate of fuel flow in a supply line between the fuel tank and a junction of the supply line with the surplus line.

8. An engine fuel supply circuit having a fuel injector, a fuel tank, a main pump for delivering fuel to the injector and a variable flow charge pump for delivering fuel from the tank to an inlet of the main pump, characterized by:
a surplus fuel line communicating unburned fuel from the injector to an inlet of the charge pump;
a bleed line communicating fuel from an outlet of the charge pump to the tank;
a bleed valve controlling flow through the bleed line;
at least one parameter sensor sensing a parameter of fuel discharged by the charge pump and generating an electrical parameter signal; and
a control unit for controlling the charge pump and the bleed valve as a function of the sensed parameter.

9. An engine fuel supply circuit having a fuel injector, a fuel tank, a main pump for delivering fuel to the injector and a variable flow charge pump for delivering fuel from the tank to an inlet of the main pump, characterized by:
a surplus fuel line communicating unburned fuel from the injector to an inlet of the charge pump;
a bleed line communicating fuel from an outlet of the charge pump to the tank;
a bleed valve controlling flow through the bleed line;
a temperature sensor sensing a temperature of fuel discharged by the charge pump and generating an electrical temperature signal;
a pressure sensor sensing a pressure of fuel discharged by the charge pump and generating an electrical pressure signal; and
a control unit for controlling the charge pump as a function of the pressure signal and controlling the bleed valve as a function of the temperature signal.

10. The fuel supply circuit of claim 9, further comprising:
a fuel flow sensor for sensing a rate of fuel flow flowing out of the fuel tank and towards the inlet of the charge pump.

11. The fuel supply circuit of claim 10, further comprising:
a pressure relief valve in the bleed line connected in parallel with the bleed valve.
